(19) United States
(12) Patent Application Publication
(10) Pub. No.: US 2016/0374491 A1
(43) Pub. Date: Dec. 29, 2016

(54) SEWING-FREE BORDER WRAPPED FOOT PAD

(71) Applicant: SHANGHAI CHINO SOL HOME TEXTILE CO.,LTD., Shanghai (CN)

(72) Inventor: CHEN-HAO CHIANG, Tao-yuan (TW)

(21) Appl. No.: 14/850,423

(22) Filed: Sep. 10, 2015

(30) Foreign Application Priority Data
Jun. 29, 2015 (CN) 201520451716.3

(51) Int. Cl. A47G 27/02; B32B 3/30; B32B 7/12; B32B 3/08; B32B 5/02

(52) U.S. Cl. CPC A47G 27/0212; B32B 3/08; B32B 5/02; B32B 7/12; B32B 3/30; A47G 27/0206; B32B 2250/02; B32B 2307/56; B32B 2471/04

(57) ABSTRACT

The utility model discloses a sewing-free border wrapped foot pad, consisting of a shock absorption core and an outer wrapping layer, wherein the outer wrapping layer is a whole piece of cloth and is adhered to the outer part of the shock absorption core, and the outer wrapping layer is provided with border embossed patterns corresponding to the shock absorption core; and embossing is formed on the surface of the shock absorption core and used for increasing the adhesive force between the shock absorption core and the outer wrapping layer and between the shock absorption core and the ground, so the foot pad has a good skid-proof effect. The product omits a sewing and border wrapping procedure, can achieve an ideal border effect, saves time, labor and cloth, and has strong practicability.

### FIELD OF THE UTILITY MODEL

The utility model relates to a foot pad.

### BACKGROUND OF THE UTILITY MODEL

According to different materials and needs of using occasions, foot pads mostly have one or more functions of water absorption, dust collection, skid resistance, floor protection, environment decoration and the like, and are widely applied to households, offices, schools, hospitals, markets and the like. The foot pads made of rubber and plastic by one-time forming have good water-proof and skid-proof effects but poor decorative effect; the foot pads, which have the functions of water absorption, dust collection, shock absorption and the like and decorate environments well at the same time, generally achieve an ideal border effect by a single sewing procedure; and because the sewing procedure is complicated, huge waste exists when cloth is cut, the labor cost is high, and the production efficiency is low.

### SUMMARY OF THE UTILITY MODEL

The aim of the utility model is to provide a sewing-free border wrapped foot pad, which is simple in structure and time-saving and labor-saving during manufacturing and also has an ideal border effect.

According to the technical scheme adopted by the utility model, a sewing-free border wrapped foot pad consists of a shock absorption core and an outer wrapping layer, wherein the outer wrapping layer is a whole piece of cloth and is adhered to the outer part of the shock absorption core; and the outer wrapping layer is provided with border embossed patterns corresponding to the shock absorption core.

The outer wrapping layer is adhered to the edges of the front and the back of the shock absorption core, and is provided with border embossed patterns corresponding to the front and the back of the shock absorption core.

Embossing is formed on the surface of the shock absorption core and used for increasing the adhesive force between the shock absorption core and the outer wrapping layer and between the shock absorption core and the ground.

The shock absorption core preferably has a square structure, and may be also in other geometric shape according to needs.

According to the utility model, the foot pad adopting the shock absorption core is comfortable in foot feel; the surface of the shock absorption core is provided with embossing, so that the adhesive force between the shock absorption core and the outer wrapping layer and between the shock absorption core and the ground is increased, and a good skid-proof effect is achieved; meanwhile, the outer wrapping layer is a whole piece of cloth and is directly adhered to the outer part of the shock absorption core, and the outer wrapping layer is provided with border embossed patterns corresponding to the front and the back of the shock absorption core, so that an ideal border effect is achieved, a complicated sewing procedure is omitted, cloth loss caused by sewing and cutting is avoided, time and labor are saved, the labor cost is reduced, the working efficiency is improved, and the foot pad is worthy of being popularized.

### BRIEF DESCRIPTION OF THE DRAWINGS

FIG. 1 is a schematic diagram of the front of the utility model;

FIG. 2 is a schematic diagram of the back of the utility model;

FIG. 3 is a schematic diagram of a core of the utility model;

FIG. 4 is an expanded schematic diagram of an outer wrapping layer of the utility model.

### DETAILED DESCRIPTION OF THE EMBODIMENTS

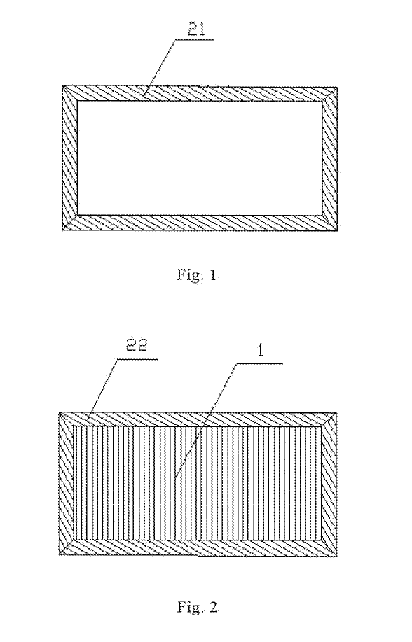

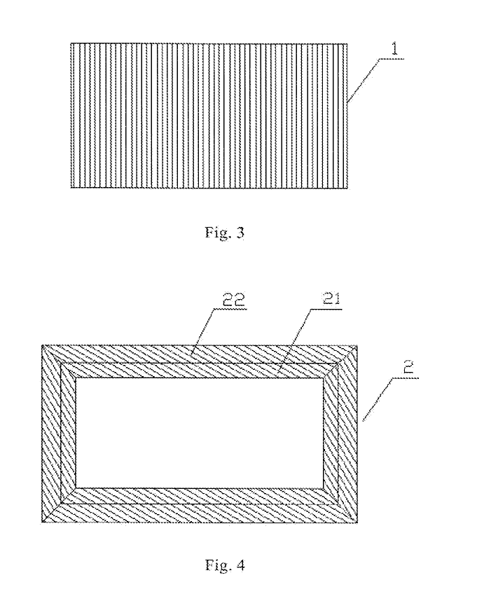

The utility model will be further described in detail below in combination with the accompanying drawings and an implementation. As shown in FIG. 1 to FIG. 4, a sewing-free border wrapped foot pad of the utility model consists of a shock absorption core 1 and an outer wrapping layer 2, wherein the outer wrapping layer 2 is a whole piece of cloth and is adhered to the edges of the front and the back of the shock absorption care 1, and the outer wrapping layer 2 is provided with border embossed patterns 21 corresponding to the front of the shock absorption core 1 and border embossed patterns 22 corresponding to the back of the shock absorption core 1. The product achieves an ideal border effect, omits a complicated sewing procedure and is low in labor cost.

Embossing is formed on the surface of the shock absorption core 1 and used for increasing the adhesive force between the shock absorption core 1 and the outer wrapping layer 2 and between the shock absorption core 1 and the ground, so a good skid-proof effect is achieved.

The shock absorption core 1 preferably has a square structure, and may be also in other geometric shape according to needs.

The shock absorption core may be made of sponge or a foamed material or a rubber material.

The above implementation is merely used for interpreting the utility model, rather than limiting the utility model in any manner. All technical schemes obtained by adopting transformations of equivalent technical means shall fall into the protection scope of the utility model.

1. A sewing-free border wrapped foot pad, consisting of a shock absorption core and an outer wrapping layer, wherein the outer wrapping layer is a whole piece of cloth and is adhered to the outer part of the shock absorption core; and the outer wrapping layer is provided with border embossed patterns corresponding to the shock absorption core.

2. The sewing-free border wrapped foot pad of claim 1, wherein the outer wrapping layer is adhered to the edges of the front and the back of the shock absorption core, and is provided with border embossed patterns corresponding to the front and the back of the shock absorption core.

3. The sewing-free border wrapped foot pad of claim 1, wherein embossing is formed on the surface of the shock absorption core.
